(19) United States
(12) Patent Application Publication
(10) Pub. No.: US 2010/0013294 A1
(43) Pub. Date: Jan. 21, 2010

(54) Lug nut for golf trolley wheel

(76) Inventor: Shu-Chen Chan, Changhua Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/219,152

(22) Filed: Jul. 17, 2008

(51) Int. Cl. B60B 27/02; B60B 27/06

(52) U.S. Cl. 301/120; 301/112

(57) ABSTRACT

A lug nut for a golf trolley wheel has a base panel, an engaging element and a spring. The base panel has a mounting hole and a chamber respectively formed transversely and radially through the base panel and communicating with each other. The engaging element is movably mounted in the base panel and has a circular hole and an engaging hole formed through the engaging element, communicating with each other and selectively aligning with the mounting hole. The spring presses the engaging element to an engaging position, wherein the engaging hole aligns with the mounting hole to mount a trolley wheel and is compressed to remove the wheel.

### BACKGROUND OF THE INVENTION

1. Field of the Invention

The present invention relates to a lug nut, and more particularly to a lug nut for a golf trolley wheel for mounting the wheel to a golf trolley conveniently.

2. Description of Related Art

Golf is a popular sport but golf courses have a large area and golfers must carry a heavy golf bag, therefore, golfers usually use a conventional golf trolley to carry the golf bag.

With reference to FIGS. 5 to 7, a conventional golf trolley has a main frame (50), a supporting bar (51), a wheel axle (55), two trolley wheels (60) and two engaging assemblies (70). The supporting bar (51) is connected to the main frame (50) and can be folded to the main frame (50). The wheel axle (55) is transversally connected to a bottom of the main frame (50) and has two free ends and two annular grooves (56). The annular grooves (56) are respectively formed on the free ends of the wheel axle (55).

The trolley wheels (60) are detachably mounted around the free ends of the wheel axle (55) and each trolley wheel (60) has an external sidewall, a mounting recess (61) and multiple threaded holes (62). The mounting recess (61) is formed on the external surface of the trolley wheel (60) around a corresponding free end of the wheel axle (55) and has a surface. The threaded holes (62) are formed in the surface of the mounting recess (61) of the trolley wheel (60).

The engaging assemblies (70) are mounted in the mounting recesses (61) of the trolley wheels (60) to hold the trolley wheels (60) on the wheel axle (55) and each engaging assembly (70) has a base panel (71), an engaging element (73), a cover (77) and a spring (76)

The base panel (71) is mounted in the mounting recess (61) of a corresponding trolley wheel (60) and has a center, an outer side, multiple fasteners (711), an axle hole (712) and multiple elongated holes (72). The fasteners (711) are mounted through the base panel (71) and in the threaded holes (62) in the mounting recess (61) to connect the base panel (71) with the trolley wheel (60). The axle hole (712) is formed through the center of the base panel (71) and is mounted around the wheel axle (55) near the free end. The elongated holes (72) are formed through the base panel (71) around the axle hole (712).

The engaging element (73) is mounted around the wheel axle (55) abuts the outer side of the base panel (71) and has two ends, a middle, two wings (74) and an engaging segment (75). The wings (74) are respectively defined on the ends of the engaging element (73). The engaging segment (75) is defined in the middle of the engaging element (73), is formed with the wings (74) and has an engaging hole. The engaging hole is formed through the engaging segment (75) and engages the annular groove (56) of the wheel axle (55) to hold the trolley wheel (60) with the wheel axle (55).

The cover (77) is mounted on the outer side of the base panel (71) to mount the engaging element (73) between the cover (77) and the base panel (71) and has an external surface, a periphery, two through holes (79) and multiple tabs (78). The through holes (79) are formed through the external surface of the cover (77) and are mounted around the wings (74). The tabs (78) are formed on the periphery of the cover (77) and are respectively riveted to the base panel (71) in the elongated holes (72) to hold the engaging element (73) between the cover (77) and the base panel (71).

The spring (76) is connected to the engaging element (73) and the cover (77) to make the engaging element (73) move relative to the cover (77) and the base panel (71). Then, the trolley wheel (60) can be separated from the wheel axle (55) by moving the wings (74) of the engaging element (73) relative to the cover (77) and the base panel (71) to make the engaging hole of the engaging segment (75) separate from the annular groove (56) of the wheel axle (55).

However, the conventional lug nut (70) for the golf trolley wheel (60) has the following shortcomings.

1. When assembling the conventional engaging assembly (70) with the trolley wheel (60), the tabs (78) of the cover (77) must be riveted in the elongated holes (72) by a riveting machine to connect the cover (77) securely with the base panel (71), and this is inconvenient and increases cost of assembling the engaging assembly (70).

2. The tabs (78) of the cover (77) are connected securely to the base panel (71) in the elongated holes (72) by a riveting process, and when the engaging element (73) or the spring (76) between the base panel (71) and the cover (77) have to be replaced, replacement takes a lot of time and skill to prevent damage to the engaging element (73) of the engaging assembly (70).

Therefore, when changing the wheel (60) of the golf trolley, the engaging assembly (70) is difficult to remove and remount on a new wheel. This is inconvenient should the wheel wear down, break or require replacement.

To overcome the shortcomings, the present invention provides a lug nut for a golf trolley wheel to mitigate or obviate the aforementioned problems.

### SUMMARY OF THE INVENTION

The main objective of the present invention is to provide a lug nut for mounting a trolley wheel to a golf trolley conveniently.

The lug nut for a golf trolley wheel in accordance with the present invention has a base panel, an engaging element and a spring. The base panel has a mounting hole and a chamber respectively formed transversely and radially through the base panel and communicating with each other. The engaging element is movably mounted in the base panel and has a circular hole and an engaging hole formed through the engaging element, communicating with each other and selectively aligning with the mounting hole. The spring presses the engaging element to an engaging position, wherein the engaging hole aligns with the mounting hole to mount a trolley wheel and is compressed to remove the wheel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lug nut in accordance with the present invention mounted on a trolley wheel;

FIG. 2 is an exploded perspective view of the lug nut in FIG. 1;

FIG. 3 is an enlarged side view in cross section of the lug nut in FIG. 1;

FIG. 4 is an operational side view in partial section of the lug nut in FIG. 1;

FIG. 5 is a perspective view of a golf trolley in accordance with the prior art;

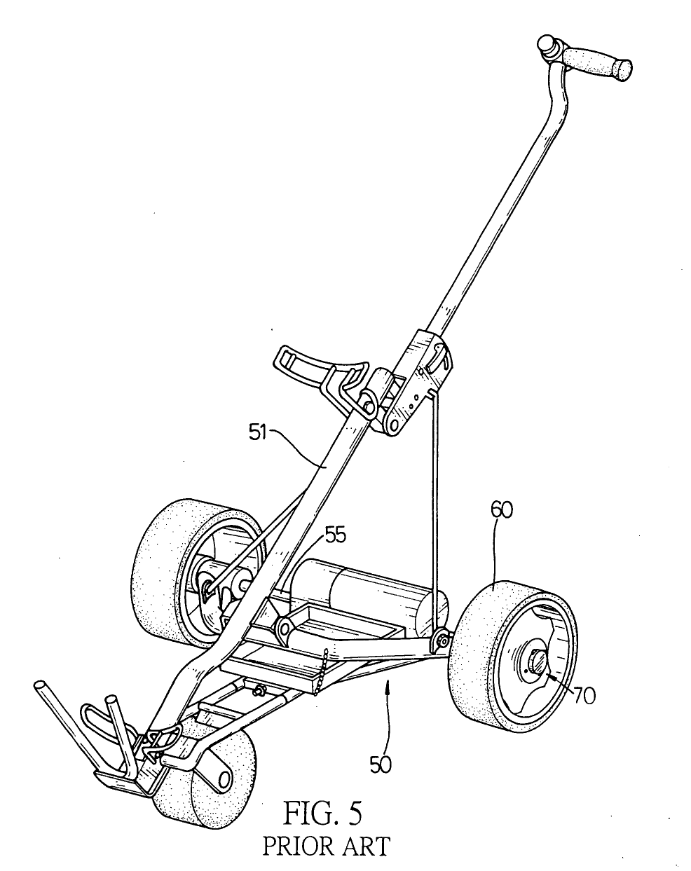

FIG. 6 is an enlarged exploded perspective view of an engaging assembly of the golf trolley in FIG. 5; and

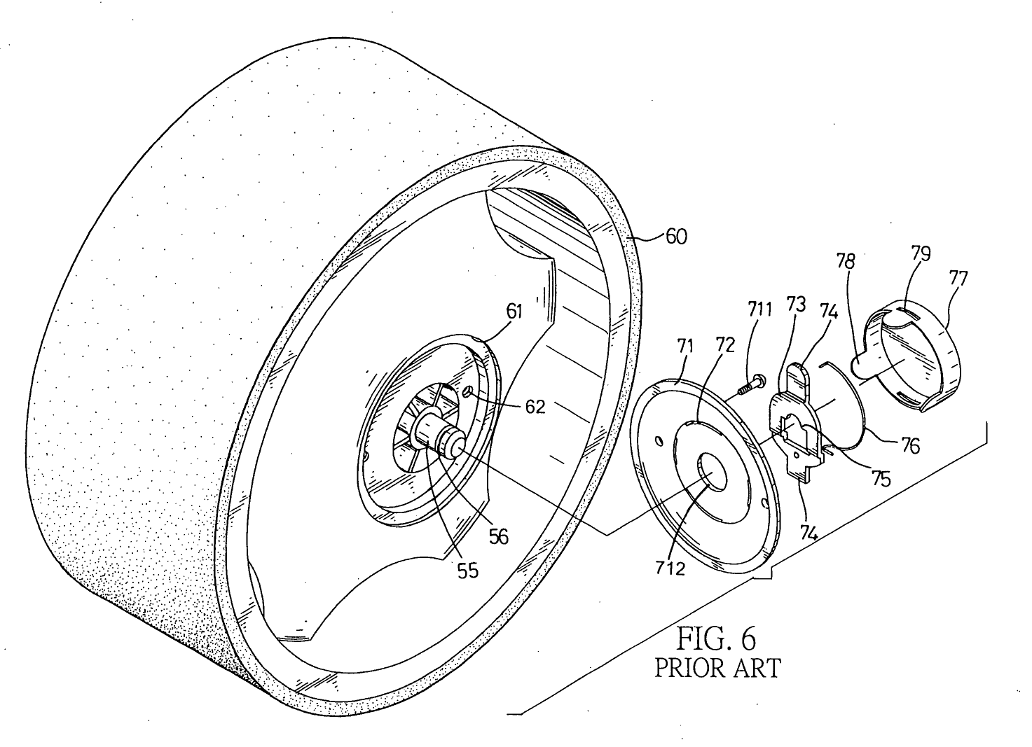

FIG. 7 is an enlarged side view in partial section of the engaging assembly in FIG. 5.

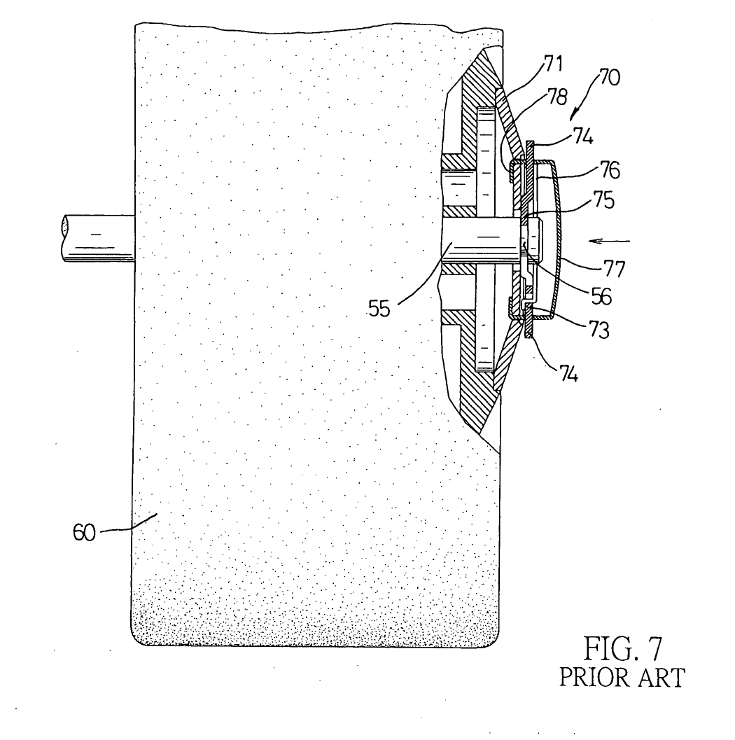

### DETAILED DESCRIPTION OF THE PREFERRED EMBODIMENT

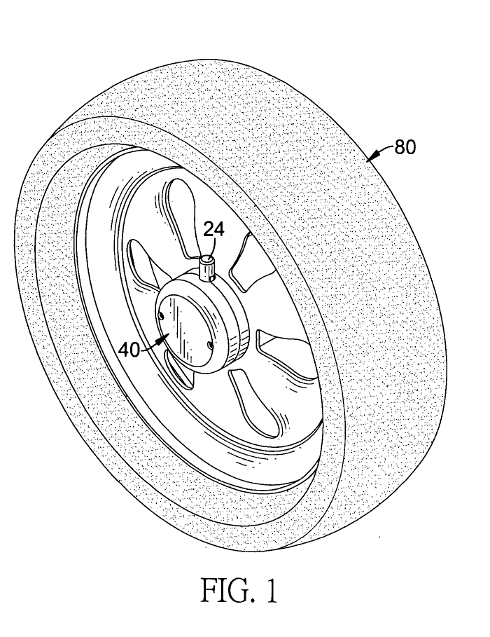

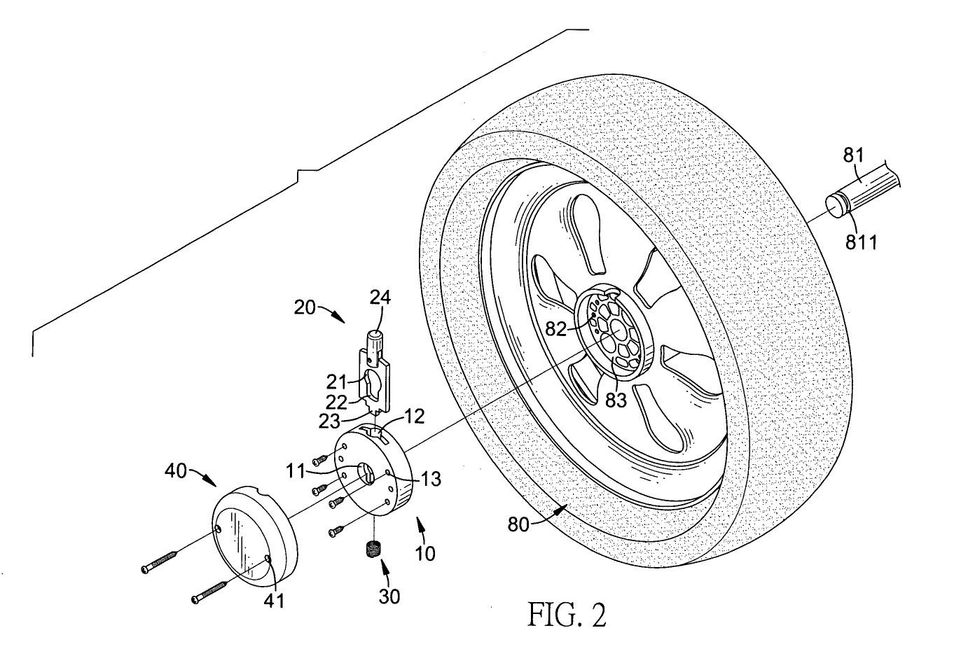

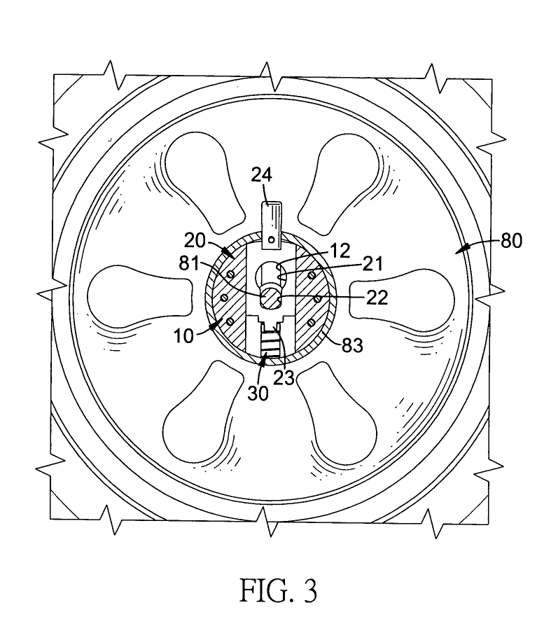

With reference to FIGS. 1 to 3, a lug nut in accordance with the present invention for a golf trolley wheel (80) having a center, an external sidewall, a wheel axle (81), multiple threaded holes (82) and a mounting recess (83), the lug nut has a base panel (10), an engaging element (20), a spring (30) and an optional cover (40).

The wheel axle (81) is connected to and extends out of the center of the trolley wheel (80) and has an external surface, two free ends and two annular grooves (811). The annular grooves (811) are respectively formed around the external surface of the wheel axle (81) near the free ends. The threaded holes (82) are formed on the external sidewall of the trolley wheel (80) around the wheel axle (81). The mounting recess (83) is formed on the external sidewall of the trolley wheel (80) around the threaded holes (82).

The base panel (10) is shaped corresponding to the mounting recess (83) of the trolley wheel (80) and has a center, an outer side, a mounting hole (11), a chamber (12) and multiple connecting holes (13).

The mounting hole (11) is formed through the center of the base panel (10) and is mounted around the one of the free ends of the wheel axle (81).

The chamber (12) is radially formed through the base panel (10) and communicates with the mounting hole (11).

The connecting holes (13) are formed in the base panel (10) around the mounting hole (11) and align with the threaded holes (82) of the trolley wheel (80).

The engaging element (20) is movably mounted in the chamber (12) of the base panel (10), engages one of the annular grooves (811) of the wheel axle (81) and has an external end, an internal end, a center, a circular hole (21), an engaging hole (22), a mounting protrusion (23) and an operating rod (24).

The circular hole (21) is formed through the center of the engaging element (20) and aligns with the mounting hole (11) of the base panel (10).

The engaging hole (22) is formed through the engaging element (20) near the internal end, communicates with the circular hole (21) and engages a corresponding annular groove (811) of the wheel axle (81).

The mounting protrusion (23) is formed on the bottom end of the engaging element (20).

The operating rod (24) is connected to the top end of the engaging element (20) and extends out of the base panel (10).

The spring (30) is mounted around the mounting protrusion (23) of the engaging element (20) between the chamber (12) of the base panel (10) and the mounting recess (83) of the trolley wheel (80) to selectively hold the engaging element (20) in an engaging position to engage the corresponding annular groove (811) of the trolley wheel (81).

The cover (40) is detachably mounted on the outer side of the base panel (10) to mount the engaging element (20) and the spring (30) in the base panel (10) between the cover (40) and the mounting recess (83) of the trolley wheel (80) and has multiple through holes (41). The through holes (41) are formed through the cover (40) and align with the connecting holes (13) of the base panel (10) and the threaded holes (82) of the trolley wheel (80).

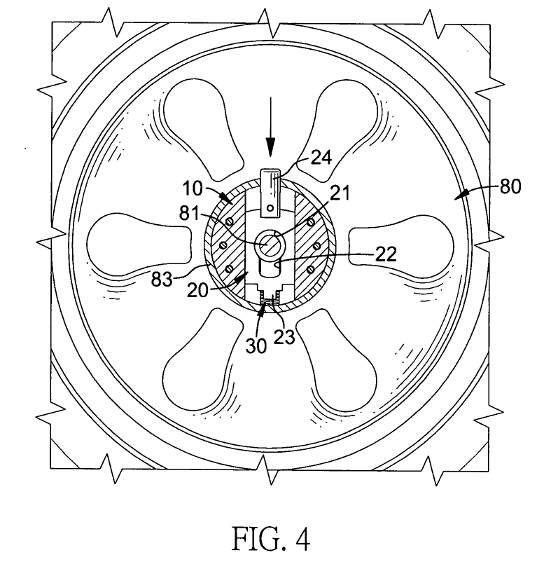

With further reference to FIG. 4, when assembling the lug nut with the wheel axle (81) and the mounting recess (83) of the trolley wheel (80), the engaging element (20) is mounted in the chamber (12) of the base panel (10) and the spring (30) is mounted on the mounting protrusion (23) of the engaging element (20). Then, the base panel (10), the engaging element (20) and the spring (30) are inserted in the mounting recess (83) of the trolley wheel (80) to make the engaging hole (22) of the engaging element (20) engage the annular groove (811) of the wheel axle (81) by the spring (30) pushing the engaging element (20) to the engaging position. Then the cover (40) is mounted on the outer side of the base panel (10) to hold and protect the engaging element (20) and the spring (30) in the base panel (10).

A user can remove the trolley wheel (80) from the wheel axle (81) by pushing the operating rod (24) to make the engaging hole (22) of the engaging element (20) separating from the annular groove (811) of the wheel axle (21). Then, the trolley wheel (80) can be separated from the wheel axle (81) conveniently.

From the above description, the lug nut for a golf trolley wheel (80) has the following advantages.

1. The base panel (10), the engaging element (20) and the spring (30) are mounted in the mounting recess (83) of the trolley wheel (80) to make the engaging hole (22) engaging the annular groove (811) of the wheel axle (81), such that operation of assembling the lug nut with the trolley wheel (80) is convenient and easy.

2. The cover (40) is mounted on the outer side of the base panel (10) to hold the lug nut with the trolley wheel (80) by multiple fasteners engaging the threaded holes (82) on the trolley wheel (80). Then, the engaging element (20) or the spring (30) can be replaced easily by separating the cover (40) and base panel (10) from the mounting recess (811) of the trolley wheel (80).

Therefore, the trolley wheel (80) can be easily replaced and removed as required.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lug nut for a golf trolley wheel having
a base panel having
a center;
an outer side;
a mounting hole being formed through the center of the base panel; and
a chamber being radially formed through the base panel and communicating with the mounting hole;
an engaging element bring movably mounted in the chamber of the base panel and having
an external end;
an internal end;
a center;
a circular hole being formed through the center of the engaging element and aligning with the mounting hole of the base panel;
an engaging hole being formed through the engaging element near the internal end and communicating with the circular hole; and
a mounting protrusion being formed on the bottom end of the engaging element; and
a spring being mounted around the mounting protrusion of the engaging element to selectively hold the engaging element in an engaging position.

2. The lug nut as claimed in claim 1, wherein the lug nut further has a cover being detachably mounted on the outer side of the base panel to mount the engaging element and the spring in the base panel.

3. The lug nut as claimed in claim 2, wherein the engaging element further has an operating rod being connected to the top end of- the engaging element and extending out of the base panel.

4. The lug nut as claimed in claim 3, wherein
the base panel further has multiple connecting holes being formed in the base panel around the mounting hole; and
the cover further has multiple through holes being formed through the cover and aligning with the connecting holes of the base panel.

5. The lug nut as claimed in claim 1, wherein the engaging element further has an operating rod being connected to the top end of the engaging element and extending out of the base panel.

6. The lug nut as claimed in claim 1, wherein
the base panel further has multiple connecting holes being formed in the base panel around the mounting hole; and
the cover further has multiple through holes being formed through the cover and aligning with the connecting holes of the base panel.

7. The lug nut as claimed in claim 2, wherein
the base panel further has multiple connecting holes being formed in the base panel around the mounting hole; and
the cover further has multiple through holes being formed through the cover and aligning with the connecting holes of the base panel.
